(19) United States
(12) Patent Application Publication
(10) Pub. No.: US 2014/0078659 A1
(43) Pub. Date: Mar. 20, 2014

(54) PORTABLE TERMINAL

(71) Applicant: Samsung Electronics Co., Ltd., Gyeonggi-do (KR)

(72) Inventor: Grzegorz IWANISZCZUK, Warsaw (PL)

(73) Assignee: Samsung Electronics Co., Ltd., Gyeonggi-do (KR)

(21) Appl. No.: 14/028,946

(22) Filed: Sep. 17, 2013

(30) Foreign Application Priority Data
Sep. 18, 2012 (KR) 10-2012-0103271

(51) Int. Cl. G06F 1/16

(52) U.S. Cl. CPC G06F 1/1666
USPC 361/679.09; 361/679.01

(57) ABSTRACT

A portable terminal includes an upper body having a lateral edge about its perimeter, a first lower body, and a second lower body. The first lower body is foldable about a horizontal axis and where first lower body is horizontally rotatable about a vertical axis to mutually cross the upper body while it is completely folded. The second lower body is fixed to a lower portion of the upper body. When completely rotated to the upper body, the first lower body is horizontally disposed side by side with the second lower body in the lower portion of the upper body, and when completely rotated to a direction that deviates from the upper body, the first lower body is unfoldable.

### CROSS RELATED APPLICATION

This application claims the benefit under 35 U.S.C. §119(a) from a Korean patent application filed in the Korean Intellectual Property Office on Sep. 18, 2012 and assigned Serial No. 10-2012-0103271, the entire disclosure of which is hereby incorporated by reference in its entirety.

### BACKGROUND

1. Field of the Invention

The present disclosure relates to a portable terminal which is an electronic device having a keyboard.

2. Description of the Related Art

Currently, as an electronic communication industry develops, portable terminals such as mobile communication terminals (cellular phones), electronic schedulers, Personal Digital Assistants (PDA), Televisions (TV), laptop computers, etc. have become a necessity of a modern life, serving as an important means for quickly and efficiently transferring information. The portable terminal makes a user's job convenient and easy to accomplish via a Graphic User Interface (GUI) environment using a touchscreen and provides various multimedia displays based on a web environment. Recently, as a demand for a portable terminal with an emphasis on portability increases, the portable terminals being brought to the market have a slimmer and lighter form.

### SUMMARY

An aspect of the present invention is to address at least some of the above-mentioned problems and/or disadvantages and to provide at least the advantages described below. Accordingly, an aspect of the present invention is to provide a portable terminal having a thin thickness by arranging elements via an optimal layout.

Another aspect of the present invention is to provide a portable terminal having a keyboard that can be folded and hidden.

Still another aspect of the present invention is to provide a portable terminal, wherein a sub-body forming a keyboard can be folded in half by a hinge connection, a first lower body folded in half can be inserted under an upper body forming a screen and hidden by a shaft connection, a second lower body forming a unit occupying a considerable volume such as a battery, a camera, etc. is fixed under the upper body, and disposed horizontally with the first lower body folded and hidden below the upper body.

In accordance with an aspect of the present invention, a portable terminal is provided. The portable terminal preferably includes an upper body having a lateral edge about its perimeter, a first lower body having side edges and which is foldable about a horizontal axis and which is horizontally rotatable about a vertical axis to mutually cross the upper body while it is completely folded position, and a second lower body fixed to a lower portion of the upper body, wherein when completely rotated into alignment with the upper body, the first lower body is horizontally disposed side by side with the second lower body in the lower portion of the upper body, and when completely rotated to a direction that deviates from the upper body, the first lower body is unfoldable.

The first lower body includes: a first sub-body; a second sub-body; and a hinge for allowing the first sub-body to be folded into an open or closed position by rotating about an axis of the hinge such that the first sub-body overlaps onto the second sub-body when in a closed position.

The upper body and the second sub-body are connected via a shaft, and wherein the first lower body is horizontally rotatable to mutually cross the upper body by the shaft when in the closed position.

When completely rotated to the upper body, the first lower body is completely overlapped and hidden by the upper body.

When completely rotated to the upper body, the first lower body does not protrude to a lateral direction of the upper body.

When completely rotated to the upper body, the first lower body does not protrude outside of the lateral side edge of the upper body.

When completely rotated towards the upper body, the first lower body is in vertical and horizontal alignment with respect to the second lower body.

When completely rotated in the direction to deviates from the upper body, the first lower body rotates by an angle of 90 degrees.

The upper body further includes a screen for displaying an image.

The screen for displaying an image comprises a touchscreen for displaying an image and receiving a touch input.

When completely rotated in the direction that deviates from the upper body and unfolded, the first lower body exposes at least one keyboard having input buttons disposed on the surface thereof.

The at least one keyboard exposed when the first lower body is unfolded comprises a QWERTY keyboard.

The at least one keyboard exposed when the first lower body is unfolded comprises a numerical keyboard.

The first sub-body and the second sub-body; each at least one keyboard that comprises input buttons which are adjacent to and in contact with each other when the first sub-body and the second sub-body are in a closed position.

The second lower body comprises at least one of a battery and a camera.

Other aspects, advantages and salient features of the PORTABLE TERMINAL in accordance with the present invention will become apparent to a person or ordinary sill in the art from the following detailed description, which, taken in conjunction with the annexed drawings, discloses embodiments of the invention.

### BRIEF DESCRIPTION OF THE DRAWINGS

The above and other aspects, features and advantages of certain embodiments of the present invention will be more apparent from the following description taken in conjunction with the accompanying drawings in which:

FIG. 1 is a perspective view illustrating an portable terminal that hides a keyboard according to an embodiment of the present invention; and

FIGS. 2, 3, 4 and 5 are views illustrating a motion of unfolding a keyboard in a portable terminal according to an embodiment of the present invention.

Throughout the drawings, like reference numerals will be understood to refer to like parts, components and structures.

### DETAILED DESCRIPTION

The following description with reference to the accompanying drawings is provided to assist in a comprehensive understanding of embodiments of the invention as defined by the claims and their equivalents. It includes various specific details to assist in that understanding but these are to be regarded as merely. Accordingly, those of ordinary skill in the art will recognize that various changes and modifications of the embodiments described herein can be made without departing from the scope and spirit of the invention. Also, in the following description, well-known functions or constructions may not be described in detail when they would obscure appreciation of the present invention by a person of ordinary skill in the art with unnecessary detail of the well-known functions and structures. Also, the terms used herein are defined according to the functions of the present invention as would be understood by a person of ordinary skill in the art. Thus, the terms may vary depending on user's or operator's intention and usage. That is, the terms used herein must be understood based on the descriptions made herein in view of the ordinary level of skill in the art.

The terms and words used in the following description and claims are not limited to the bibliographical meanings, but, are merely used by the inventor to enable a clear and consistent understanding of the invention. Accordingly, it should be apparent to those skilled in the art that the following description of embodiments of the present invention are provided for illustration purpose only and not for the purpose of limiting the invention as defined by the appended claims and their equivalents.

The present invention relates to an electronic device having a keyboard. Hereunder a portable terminal may be used as an example of the electronic device but the present invention is not limited to the particular embodiment of portable terminals described herein as will be apparent to one skilled in the art.

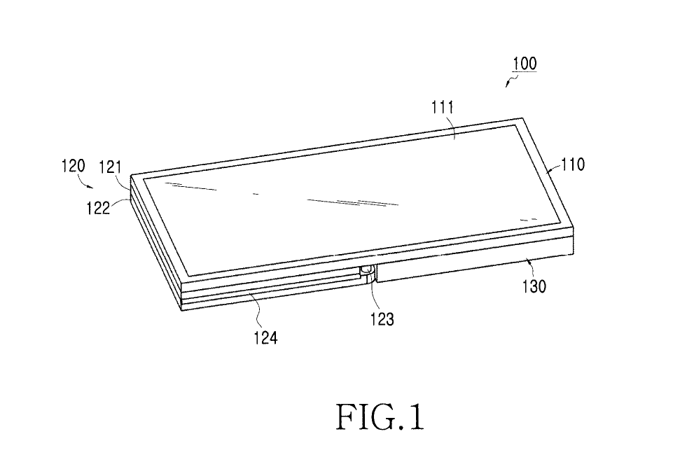

FIG. 1 is a perspective view illustrating a portable terminal that hides a keyboard according to an embodiment of the present invention.

Referring to FIG. 1, the portable terminal 100 includes an upper body 110, a first lower body 120, and a second lower body 130.

The first lower body 120 can be folded and can be rotated to mutually cross the upper body 110 while it is completely folded.

The second lower body 130 is fixed to the lower portion of the upper body 110.

When completely rotated to the upper body 110, the first lower body 120 is horizontally disposed side by side in the same horizontal plane with the second lower body 130 in the lower portion of the upper body 110.

Also, when completely rotated in a direction that deviates from the upper body 110, the first lower body 120 is not covered by the upper body 110 and becomes in a state where the first lower body 120 can be unfolded.

The first lower body 120 includes a first sub-body 121 and a second sub-body 122. The first sub-body 121 and the second sub-body 122 are connected via a hinge 124. The first sub-body 121 when in the folded position overlaps the second sub-body 122, or can be unfolded from the second sub-body 122 such that first sub-body and second sub-body are aligned side by side in the same horizontal plane.

The upper body 110 and the second sub-body 122 of the first lower body 120 are connected via a vertically oriented shaft 123, and the first lower body 120 in its completely folded state can be horizontally rotated about the vertical axis of shaft 123 so that the first lower body 120 is in side by side horizontal alignment with the second-lower body 130 to mutually cross the upper body 110.

When completely rotated to the upper body 110, the completely folded first lower body 120 is disposed under the upper body 110, which hides the first lower body 120. For example, when completely rotated to the upper body 110, the completely folded first lower body 120 does not protrude from the perimeter of the lateral side edges of the upper body 110. When the portable terminal 100 is viewed from above, the first lower body 120 is overlapped completely and hidden by the upper body 110 and only the upper body 110 is viewed.

Also, the thickness of the completely folded first lower body 120 coincides with the thickness of the second lower body 130 such that the bottom and the top of the first lower body and the second lower body are each respectively in the same horizontal plane.

Also, as depicted in FIG. 1, when the completely folded first lower body 120 and the second lower body 130 are horizontally disposed side by side with the upper body 110, the first lower body 120 does not protrude or is not elevated with respect to the second lower body 130 in other words, the side edges of the first lower body and the second lower body are in vertical alignment and are aligned in the same horizontal plane

The upper body 110 may include a screen 111 for displaying an image. The screen 111 may be a touchscreen allowing a touch input for a multimedia GUI. Also, the upper body 110 may also include a speaker that outputs sounds, a microphone that receives sounds, and various sensors. Furthermore, the upper body 110 may also include a mainboard. The mainboard is a substrate containing a basic circuit and parts, sets an execution and operating environment of the portable terminal, stores and maintains information thereof, allows the portable terminal to be stably driven, and enables swift data input/output exchange of all units of the portable terminal.

The first sub-body 121 of the first lower body 120 forms a first keyboard 1211 where input buttons are disposed, and the second sub-body 122 of the first lower body 120 also forms a second keyboard 1221 where input buttons are disposed.

The first lower body 120 forms electronic elements for the first keyboard 1211, for example, a substrate, buttons, etc., and the second sub-body 1221 includes similar components.

When the first lower body 120 is completely folded, that is, the first sub-body 121 and the second sub-body 122 completely overlap each other, the first keyboard 1211 and the second keyboard 1221 contact each other in a face to face orientation such that the keyboard buttons are directly adjacent to each other and are hidden from view.

Meanwhile, when the completely folded first lower body 120 is completely unfolded horizontally and rotated about the axis of shaft 123 to mutually cross the upper body 110, the first sub-body 121 and the second sub-body 122 can be readily unfolded via hinge 124.

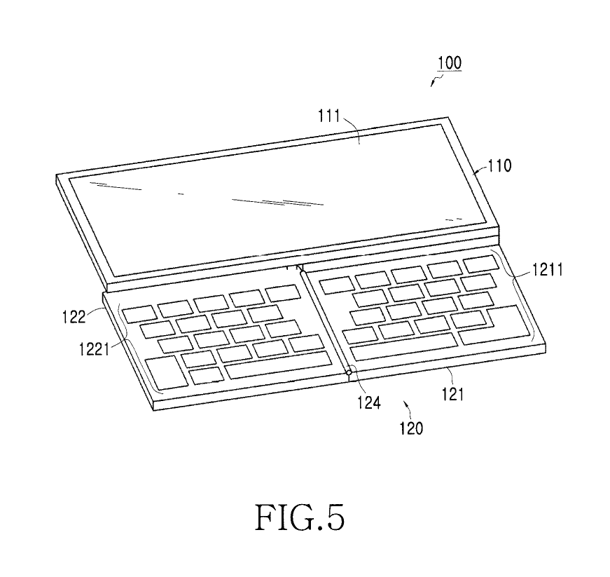

As depicted in FIG. 5, the first sub-body 121 and the second sub-body 122 may be completely unfolded into their horizontal state and arranged in side by side horizontal orientation.

Also, when the first sub-body 121 and the second sub-body 122 are completely unfolded, the first keyboard 1211 and the second keyboard 1221 are exposed such that they may be accessed for use by a user's.

The first keyboard 1211 or the second keyboard 1221 can form a numerical keyboard where numerical buttons are disposed.

Also, in an alternate embodiment the unfolded first keyboard 1211 and second keyboard 1221 may merge to form one QWERTY keyboard.

The second lower body 130 includes other parts and electrical units contained within and having a thick thickness that is approximately equivalent to the first lower keyboard 120. These parts contained within the second lower body may be a battery, a camera, etc.

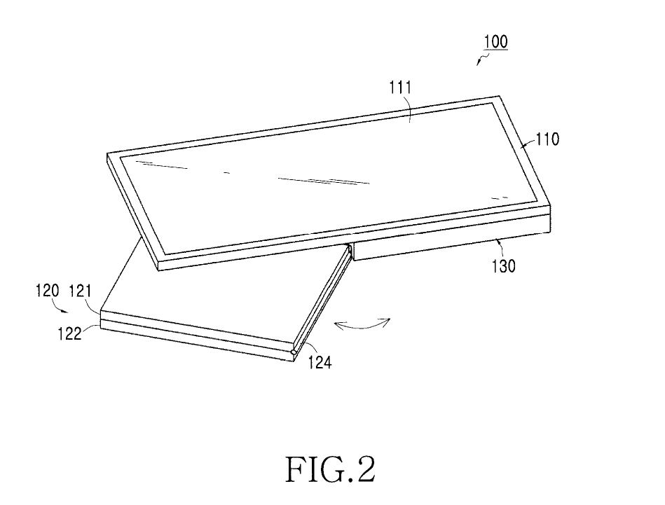

FIGS. 2 to 5 are views illustrating the sequential steps and a motion of unfolding a keyboard in a portable terminal according to an embodiment of the present invention.

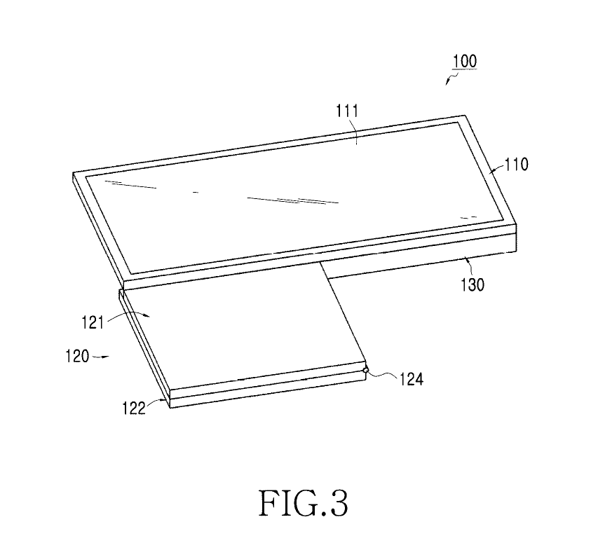

Referring to FIGS. 2 and 3, the completely folded first lower body 120 is rotated to mutually cross the upper body 110 by the shaft 123 and about the axis of shaft 123, so that the first lower body 120 is completely rotated unfolded to the outside of the upper body 110. For example, when the folded first lower body 120 is rotated by an angle of 90 degrees from a state where the first lower body 120 is positioned under the upper body 110, the first lower body 120 is completely unfolded from the upper body 110 such that the lower body 120 is not overlapped by the upper body 110.

An elastic member (not shown) such as a spring may be applied to the shaft 123 that connects the upper body 110 with the second sub-body 122, so that the folded first lower body 120 can be automatically unfolded from the upper body 110. For an embodiment which includes an elastic member for automatically unfolding the lower body 120, means for starting a motion of unfolding the unfolded first lower body 120 from the upper body 110, for example, a mechanical button may be configured. When this mechanical button is pressed a latch may be released such that, the folded first lower body 120 starts to automatically unfold from the upper body 110 and rotates by an angle of 90 degrees, so that the first lower body 120 can be completely unfolded from the upper body 110 as shown if FIG. 3.

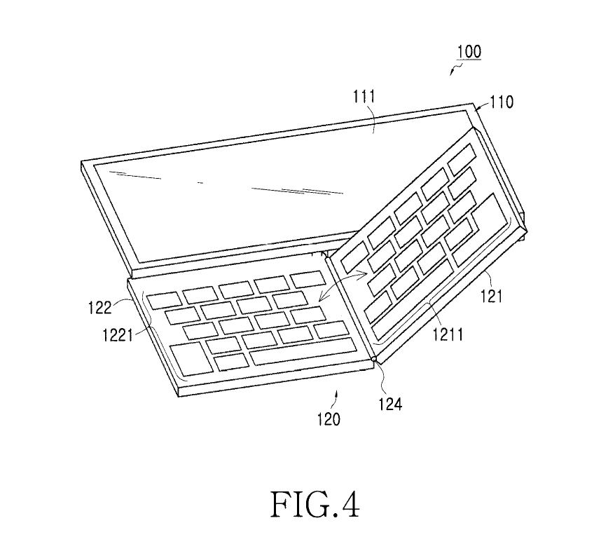

Referring to FIGS. 4 and 5, with the folded first lower body 120 completely unfolded from the upper body 110, the first sub-body 121 is rotated along the hinge 123 and can be unfolded from the second sub-body 122.

An elastic member such as a spring (not shown) may be applied to the hinge 124 that connects the first sub-body 121 with the second sub-body 122, so that the folded first sub-body 121 can be automatically unfolded from the second sub-body 122.

When rotated by an angle of 180 degrees, the first sub-body 121 is completely unfolded from the second sub-body 122, and the first sub-body 121 and the second sub-body 122 are disposed horizontally along the same horizontal plane.

The first sub-body 121 is completely unfolded from the second sub-body 122, and the keyboard 1211 of the first sub-body 121 and the keyboard 1221 of the second sub-body 122 are arranged in side by side alignment and merge to form one qwerty keyboard.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

The portable terminal according to the present invention forms a foldable keyboard. The folded keyboard can be hidden under the screen. Since units occupying a considerable volume such as a battery, a camera, etc. are disposed side by side horizontally with the keyboard folded under the screen, the thickness of the portable terminal may be reduced.

What is claimed is:

1. An electronic device, the device comprising:
an upper body having a lateral edge about its perimeter;
a first lower body having side edges and wherein the first lower body is foldable about a horizontal axis and where the first lower body is horizontally rotatable about a vertical axis to mutually cross the upper body while it is in a completely folded position; and
a second lower body fixed to a lower portion of the upper body,
wherein when completely rotated into alignment with the upper body, the first lower body is horizontally disposed side by side with the second lower body beneath the lower portion of the upper body, and when completely rotated to a direction that deviates from the upper body, the first lower body is unfoldable.

2. The device of claim 1, wherein the first lower body comprises:
a first sub-body;
a second sub-body; and
a hinge for allowing the first sub-body to be folded into an open or closed position by rotating about an axis of the hinge such that the first sub-body overlaps onto the second sub-body when in the closed position.

3. The device of claim 2, wherein the upper body and the second sub-body are connected via a shaft, and wherein the first lower body is horizontally rotatable to mutually cross the upper body by the shaft when in the closed position.

4. The device of claim 1, wherein when completely rotated to the upper body, the first lower body is completely overlapped and hidden by the upper body.

5. The device of claim 1, wherein when completely rotated to the upper body, the first lower body does not protrude outside of the lateral side edge of the upper body.

6. The device of claim 1, wherein when completely rotated towards the upper body, the first lower body is in vertical and horizontal alignment with respect to the second lower body.

7. The device of claim 1, wherein when completely rotated in the direction that deviates from the upper body, the first lower body is automatically unfolded.

8. The device of claim 1, wherein when completely rotated in the direction to deviate from the upper body, the first lower body rotates by an angle of 90 degrees.

9. The device of claim 1, wherein the upper body further includes a screen for displaying an image.

10. The device of claim 9, wherein the screen for displaying an image comprises a touchscreen for displaying an image and receiving a touch input.

11. The device of claim 1, wherein when completely rotated in the direction that deviates from the upper body and unfolded, the first lower body exposes at least one keyboard having input buttons disposed on the surface thereof.

12. The device of claim 11, wherein the at least one keyboard exposed when the first lower body is unfolded comprises a QWERTY keyboard.

13. The device of claim 11, wherein the at least one keyboard exposed when the first lower body is unfolded comprises a numerical keyboard.

14. The device of claim 2, wherein the first sub-body and the second sub-body; each at least one keyboard that comprises input buttons which are adjacent to and in contact with each other when the first sub-body and the second sub-body are in a closed position.

15. The device of claim 1, wherein the second lower body comprises at least one of a battery and a camera.

16. An electronic device, the device comprising:
a first body having a lateral side edge about its perimeter;
a first lower body having a first sub-body and a second sub-body which may be folded along a horizontal axis and wherein the first lower body is horizontally rotatable to mutually cross the first body while it is folded; and
a second lower body fixed to a lower portion of the first body,
wherein when rotated to the first body, the first lower body is horizontally disposed side by side with the second lower body in the lower portion of the first body; and
wherein when rotated to a direction that deviates from the first body, the first sub-body and the second sub-body may be placed in an unfolded position.

17. The electronic device according to claim 16, wherein the first lower body further includes a hinge for allowing the first sub-body and the second sub-body to be folded along a horizontal axis.

18. The electronic device according to claim 16 wherein the first body and the second sub-body are connected via a shaft, and wherein the first lower body is horizontally rotatable about a vertical axis to mutually cross the upper body by the shaft when in the closed position.

19. The electronic device according to claim 16, wherein when completely rotated to the first body, the first lower body is completely overlapped and hidden by the first body.

20. The electronic device according to claim 16, wherein when completely rotated to the first body, the first lower body does not protrude outside of the lateral side edge of the first body.
